(19) United States
(12) Patent Application Publication
(10) Pub. No.: US 2018/0227779 A9
(43) Pub. Date: Aug. 9, 2018

(54) METHOD AND APPARATUS FOR MULTIMEDIA BROADCAST SINGLE FREQUENCY NETWORK MEASUREMENTS

(71) Applicant: NOKIA TECHNOLOGIES OY, Espoo (FI)

(72) Inventors: Lars Dalsgaard, Oulu (FI); Ilkka Keskitalo, Oulu (FI); Jorma Kaikkonen, Oulu (FI)

(21) Appl. No.: 15/125,819

(22) PCT Filed: Mar. 12, 2015
(86) PCT No.: PCT/FI2015/050159

§ 371 Date: Sep. 13, 2016

Related U.S. Application Data
(60) Provisional application No. 61/954,288, filed on Mar. 17, 2014.

(51) Int. Cl. H04W 24/08; H04W 4/06; H04W 72/04; H04W 72/00; H04W 72/08

(52) U.S. Cl. CPC H04W 24/08; H04W 4/06; H04W 72/08; H04W 72/005; H04W 72/0453

(57) ABSTRACT

A method, apparatus and computer program product are provided for multimedia broadcast single frequency network measurements. A method is provided for receiving a multimedia broadcast single frequency network measurement request (32); and measuring, at a user equipment, multimedia broadcast single frequency network parameters, wherein the multimedia broadcast single multimedia broadcast single frequency network measurement is independent of the user equipment radio resource control state (34).

### TECHNOLOGICAL FILED

An example embodiment of the present invention relates to wireless communication signal measurements and, more particularly, multimedia broadcast single frequency network measurements.

### BACKGROUND

Currently multimedia broadcast single frequency network (MBSFN) measurements are being defined for a UE for each radio resource control (RRC) state, e.g. idle and connected. Additionally existing mobility measurement requirements are defined for a UE in idle and connected mode for a user equipment (UE) and in RRC connected mode are defined separately for when the UE connected mode discontinuous reception (DRX) or C-DRX is applied or not applied.

Typical measurement requirements are dependent on the DRX cycle, e.g. idle DRX or C-DRX, measurement gap pattern of inter-frequency measurement. Measurements are aligned with the DRX cycles when the UE would otherwise need to activate its receiver, e.g. for paging reception or physical downlink control channel (PDCCH) monitoring. In the case of a MBSFN the UE behavior regarding the multimedia broadcast multicast service (MBMS) reception is not linked to paging or peer-to-peer (P2P) PDCCH monitoring, e.g. standard one-to-one point transmission based on cell radio network temporary identifiers (C-RNTI). Instead, MBMS reception relies on a physical multicast channel (PMCH). Multimedia broadcast (MCSM) and PMCH monitoring is the same for both modes, idle and connected, and the UE activity is restricted by these same parameters.

### BRIEF SUMMARY

A method, apparatus and computer program product are provided in accordance with an example embodiment in order to facilitate multimedia broadcast single frequency network (MBSFN) measurements. In an example embodiment, a method is provided that includes receiving a multimedia broadcast single frequency network measurement request; and measuring, at a user equipment, multimedia broadcast single frequency network parameters. The multimedia broadcast single frequency network measurement is independent of the user equipment radio resource control state. In an example embodiment, the method also includes causing the transmission of the multimedia broadcast single frequency network measurement data. In an example embodiment of the method, the multimedia broadcast single frequency network measurement is based on a multimedia broadcast monitoring or reception.

In an example embodiment of the method, the multimedia broadcast single frequency network measurement is reference signal received power and reference signal received quality. In an example embodiment of this method, a received signal strength averaging associated with the reference signal received power or reference signal received quality is based on orthogonal frequency-division multiplexing symbols carrying multimedia broadcast single frequency network or MBMS reference signals. In an example embodiment of the method, the multimedia broadcast single frequency network measurement is a multicast channel block error rate per modulation coding scheme per multimedia broadcast single frequency network area. In an example embodiment of the method, the multimedia broadcast single frequency network measurement is performed during sub-frames and carriers when the user equipment is decoding a physical multicast channel.

In another example embodiment, an apparatus is provided that includes at least one processor and at least one memory including computer program code with the memory and computer program code configured to, with the processor, cause the apparatus to receive a multimedia broadcast single frequency network measurement request; and measure, at a user equipment, multimedia broadcast single frequency network parameters. The multimedia broadcast single frequency network measurement is independent of the user equipment radio resource control state. The at least one memory and computer program code may be further configured to, with the processor, cause the apparatus of an example embodiment to cause the transmission of the multimedia broadcast signal network measurement data. In an example embodiment of the apparatus, the multimedia broadcast single frequency network measurement is based on a multimedia broadcast monitoring or reception.

In an example embodiment of the apparatus, the multimedia broadcast single frequency network measurement is reference signal received power and reference signal received quality. In that regard, a received signal strength averaging associated with the reference signal received power or reference signal received quality may be based on orthogonal frequency-division multiplexing symbols carrying multimedia broadcast single frequency network or MBMS reference signals. In an example embodiment of the apparatus, the multimedia broadcast single frequency network measurement is a multicast channel block error rate per modulation coding scheme per multimedia broadcast single frequency network area. In the apparatus of an example embodiment, the multimedia broadcast single frequency network measurement is performed during sub-frames and carriers when the user equipment is decoding a physical multicast channel.

In a further embodiment, a computer program product is provided that includes at least one non-transitory computer readable medium having program code portions stored thereon with the program code portions configured, upon execution, to receive a multimedia broadcast single frequency network measurement request; and measure, at a user equipment, multimedia broadcast single frequency network parameters, wherein the multimedia broadcast single frequency network measurement is independent of the user equipment radio resource control state. The computer-executable program code portions of an example embodiment may also include program code instructions configured to cause the transmission of the multimedia broadcast signal network measurement data. In an example embodiment of the computer program product, the multimedia broadcast single frequency network measurement is based on a multimedia broadcast monitoring or reception.

In an example embodiment of the computer program product, the multimedia broadcast single frequency network measurement is reference signal received power and reference signal received quality. In that regard, a received signal strength averaging associated with the reference signal received power or reference signal received quality may be based on orthogonal frequency-division multiplexing symbols carrying multimedia broadcast single frequency network or MBMS reference signals. In an example embodiment of the computer program product, the multimedia broadcast single frequency network measurement is a multicast channel block error rate per modulation coding scheme per multimedia broadcast single frequency network or MBMS area. In an example embodiment of the computer program product, the multimedia broadcast single frequency network measurement is performed during sub-frames and carriers when the user equipment is decoding a physical multicast channel.

In yet another example embodiment, an apparatus is provided that includes means for receiving a multimedia broadcast single frequency network measurement request; and means for measuring, at a user equipment, multimedia broadcast single frequency network parameters by a user equipment. The multimedia broadcast single frequency network measurement is independent of the user equipment radio resource control state.

### BRIEF DESCRIPTION OF THE DRAWINGS

Having thus described example embodiments of the invention in general terms, reference will now be made to the accompanying drawings, which are not necessarily drawn to scale, and wherein:

FIG. 1 illustrates a network communications diagram in accordance with an example embodiment of the present invention;

FIG. 2 is a block diagram of an apparatus that may be specifically configured for multimedia broadcast single frequency network measurements in accordance with an example embodiment of the present invention; and

FIG. 3 is a flow chart illustrating the operations performed, such as by the apparatus of FIG. 2, in accordance with an example embodiment of the present invention.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium,” which refers to a non-transitory physical storage medium (e.g., volatile or non-volatile memory device), can be differentiated from a “computer-readable transmission medium,” which refers to an electromagnetic signal.

A method, apparatus, and computer program product are provided in accordance with an example embodiment for multimedia broadcast single frequency network measurements.

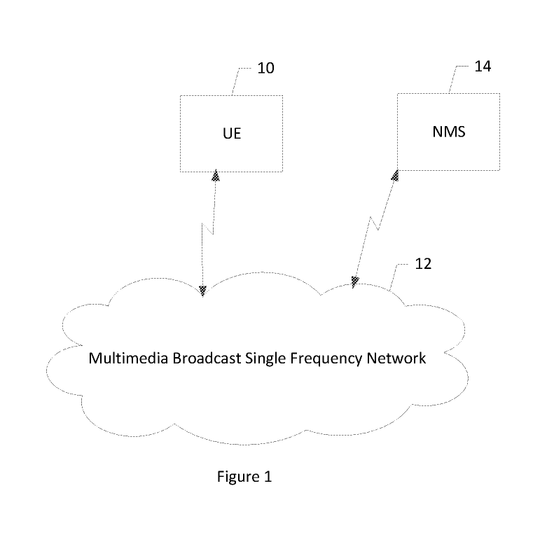

FIG. 1 illustrates a network communication diagram including a UE 10, a multimedia broadcast single frequency network (MBSFN) 12. The MBSFN can be a part of a wireless communication network like a mobile radio access network. The UE 10 may receive a MBSFN measurement request via the wireless communication network. The MBSFN measurement request may be received triggered by a network management system (NMS) 14 and sent through wireless communication. The measurement request may cause the UE 10 to measure, collect, and report MBSFN measurement data to the network. The NMS may include a minimization of drive tests (MDT)—function which may initiate the MBSFN measurements, trigger the measurement configuration to be sent by the wireless communication network and collect the reported data. The example embodiment utilizing MDT functionality is for illustration purposes and one skilled in the art would appreciate other methods for causing the UE 10 to measure, collect, and report, MBSFN measurement data or to specify the measurement configuration of the MBSFN radio reception measurements to be collected and reported to the network may be employed.

In response to the MBSFN measurement request the UE 10 may measure MBSFN 12 parameters according to performance requirements, such as 3GPP (third generation partnership project) technical specification (TS) 36.133 or requirements similar to channel state information (CSI) measurements of TS 36.101. The UE 10 may measure MBSFN 12 parameters, such as MBSFN reference signal received power (RSRP) and reference signal received quality (RSRQ). The received signal strength indicator (RSSI) averaging associated with the RSRP and RSRQ measurements may be performed based on orthogonal frequency-division multiplexing symbols carrying MBSFN 12 reference signals. The MBSFN 12 measurement performed by the UE 10 may, additionally or alternatively, be a multicast channel (MCH) block error rate (BLER) per modulation coding scheme (MCS) per MBSFN area.

In an example embodiment, the MBSFN 12 measurement performed by the UE 10 may be performed during sub-frames and carriers of the MBMS in an instance in which the UE is decoding a physical multicast channel (PMCH).

In order to make the UE 10 behavior consistent for MBSFN 12 measurements, the UE MBSFN measurement requirements may be independent of the radio resource control state, e.g. idle or connected. Instead, the UE 10 MBSFN measurement requirements may be based on the MBMS 12 monitoring and reception requirements, regardless of the RRC state. MBMS 12 monitoring and reception requirements may be based on the control and traffic information of the respective multicast control channel (MCCH) and multicast traffic channel (MTCH). For example, in an instance in which the network changes some of the MCCH information, the network notifies the UE 10 about the change during a first modification period, in the next modification period the network transmits the updated MCCH information. As such, the UE 10 may monitor the modification of the MCCH information independent of whether active reception, such as MBMS, is occurring or not.

Additionally or alternatively, the MBSFN measurement requirements may be based on MBMS scheduling and/or the UE 10 service requirements. Therefore, the UE MBSFN measurement requirements may be the same for both the RCC idle and RCC connected modes, and transparent to the RCC state.

The UE 10 may collect and report the MBSFN 12 measurements to the network, for example, the UE may report the MBSFN measurements to the NMS 14 using MDT functionality. The MBSFN 12 measurement data may include, without limitation, one or more of the RSRP, RSRQ, MCH BLER per MCS per MBSFN area, or the like.

### Example Apparatus

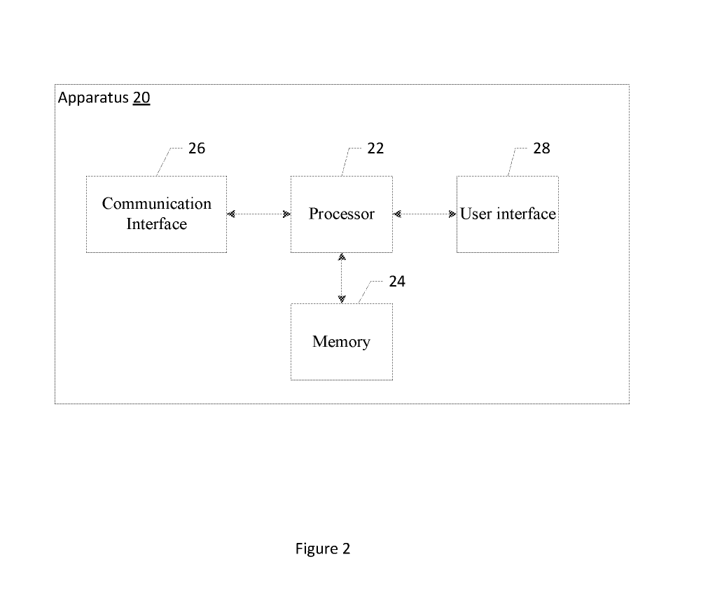

A UE 10 may include or otherwise be associated with an apparatus 20 as shown in FIG. 2. The apparatus, such as that shown in FIG. 2, is specifically configured in accordance with an example embodiment of the present invention to provide for multimedia broadcast single frequency network measurements. The apparatus may include or otherwise be in communication with a processor 22, a memory device 24, a communication interface 26 and an optional user interface 28. In some embodiments, the processor (and/or co-processors or any other processing circuitry assisting or otherwise associated with the processor) may be in communication with the memory device via a bus for passing information among components of the apparatus. The memory device may be non-transitory and may include, for example, one or more volatile and/or non-volatile memories. In other words, for example, the memory device may be an electronic storage device (e.g., a computer readable storage medium) comprising gates configured to store data (e.g., bits) that may be retrievable by a machine (e.g., a computing device like the processor). The memory device may be configured to store information, data, content, applications, instructions, or the like for enabling the apparatus to carry out various functions in accordance with an example embodiment of the present invention. For example, the memory device could be configured to buffer input data for processing by the processor. Additionally or alternatively, the memory device could be configured to store instructions for execution by the processor.

As noted above, the apparatus 20 may be embodied by UE 10. However, in some embodiments, the apparatus may be embodied as a chip or chip set. In other words, the apparatus may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus may therefore, in some cases, be configured to implement an embodiment of the present invention on a single chip or as a single “system on a chip.” As such, in some cases, a chip or chipset may constitute means for performing one or more operations for providing the functionalities described herein.

The processor 22 may be embodied in a number of different ways. For example, the processor may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor may include one or more processing cores configured to perform independently. A multi-core processor may enable multiprocessing within a single physical package. Additionally or alternatively, the processor may include one or more processors configured in tandem via the bus to enable independent execution of instructions, pipelining and/or multithreading.

In an example embodiment, the processor 22 may be configured to execute instructions stored in the memory device 24 or otherwise accessible to the processor. Alternatively or additionally, the processor may be configured to execute hard coded functionality. As such, whether configured by hardware or software methods, or by a combination thereof, the processor may represent an entity (e.g., physically embodied in circuitry) capable of performing operations according to an embodiment of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the algorithms and/or operations described herein when the instructions are executed. However, in some cases, the processor may be a processor of a specific device (e.g., a mobile terminal or a fixed computing device) configured to employ an embodiment of the present invention by further configuration of the processor by instructions for performing the algorithms and/or operations described herein. The processor may include, among other things, a clock, an arithmetic logic unit (ALU) and logic gates configured to support operation of the processor.

The apparatus 20 of an example embodiment may also include a communication interface 26 that may be any means such as a device or circuitry embodied in either hardware or a combination of hardware and software that is configured to receive and/or transmit data from/to a communications device in communication with the apparatus, such as to facilitate communications with one or more user equipment 10 or the like. In this regard, the communication interface may include, for example, an antenna (or multiple antennas) and supporting hardware and/or software for enabling communications with a wireless communication network. Additionally or alternatively, the communication interface may include the circuitry for interacting with the antenna(s) to cause transmission of signals via the antenna(s) or to handle receipt of signals received via the antenna(s). In some environments, the communication interface may alternatively or also support wired communication. As such, for example, the communication interface may include a communication modem and/or other hardware and/or software for supporting communication via cable, digital subscriber line (DSL), universal serial bus (USB) or other mechanisms.

The apparatus 20 may also optionally include a user interface 28 that may, in turn, be in communication with the processor 22 to provide output to the user and, in some embodiments, to receive an indication of a user input. As such, the user interface may include a display and, in some embodiments, may also include a keyboard, a mouse, a joystick, a touch screen, touch areas, soft keys, one or more microphones, a plurality of speakers, or other input/output mechanisms. In one embodiment, the processor may comprise user interface circuitry configured to control at least some functions of one or more user interface elements such as a display and, in some embodiments, a plurality of speakers, a ringer, one or more microphones and/or the like. The processor and/or user interface circuitry comprising the processor may be configured to control one or more functions of one or more user interface elements through computer program instructions (e.g., software and/or firmware) stored on a memory accessible to the processor (e.g., memory device 24, and/or the like).

Example Flowchart for Multimedia Broadcast Single Frequency Network Measurements

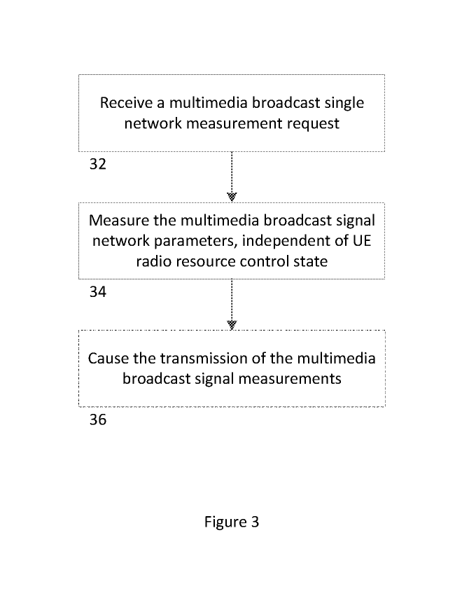

Referring now to FIG. 3, the operations performed, such as by the apparatus 20 of FIG. 2, for multimedia broadcast single frequency network measurements is illustrated. As shown in block 32 of FIG. 3, the apparatus may include means, such as the processor 22, communications interface 26, or the like, configured to receive a MBSFN measurement request. The communications interface 26 may receive the MBSFN measurement request from the NMS 14. The NMS 14 may utilize, for example, the trace function to send the MBSFN measurement request.

As shown in block 34 of FIG. 3, the apparatus 20 may include means, such as a processor 22, communications interface 26, or the like, configured to measure MBSFN 12 parameters independent of RRC state, such as by measuring one or more MBSFN parameters regardless of whether the UE is connected, idle, or in another state. The processor 22 may, for example, utilize MTD functionality for the measurement configuration to specify the MBSFN radio reception measurements to be collected. Alternatively, the MBSFN radio reception measurements to be collected may be predefined. In response to the MBSFN measurement request, the processor 22 may cause the communications interface 26 to measure MBSFN parameters according to performance requirements, such as 3GPP TS 36.133.

The apparatus 20, such as the processor 22 and/or the communications interface 26, may measure MBSFN 12 parameters such as MBSFN reference signal received power (RSRP) and reference signal received quality (RSRQ). The received signal strength indicator (RSSI) averaging associated with the RSRP and RSRQ measurements may be performed, such as by the processor 22 and/or the communications interface 26, based on orthogonal frequency-division multiplexing symbols carrying MBSFN 12 or MBMS reference signals. The MBSFN 12 measurements performed by the processor 22, communications interface 26, or the like may, additionally or alternatively, be a multicast channel (MCH) block error rate (BLER) per modulation coding scheme (MCS) per MBSFN area.

In an example embodiment, the MBSFN measurement may be performed during sub-frames and carriers in an instance in which the processor 22 is decoding a physical multicast channel (PMCH).

The MBSFN 12 measurement requirements may be independent of the RRC state, e.g. idle or connected. In an example embodiment, the MBSFN 12 measurement requirements may, instead, be based on the MBSFN monitoring and reception requirements. MBSFN 12 monitoring and reception requirements may be based on the control and traffic information of the respective multicast control channel (MCCH) and multicast traffic channel (MTCH). Additionally or alternatively, the MBSFN 12 measurement requirements may be based on MBMS scheduling and/or UE service requirements. Therefore, in an example embodiment, the MBSFN 12 measurement requirements may be the same for both the RCC idle and RCC connected modes, and transparent to the RCC state.

As shown in block 36 of FIG. 3, the apparatus 20 may include a means, such as a processor 22, communications interface 26, or the like, configured to cause the transmission of the MBSFN measurement data. The processor 22 may utilize MDT functionality to compile and transmit, or report, the MBSFN measurement data. The processor 22 may cause the communications interface 26 to transmit the MBSFN measurement data to the network, e.g. the NMS 14, using the tracing function.

In an example embodiment in which the MBSFN measurements are based on the MBMS reception requirements, the MBMS reception requirements define the measurements and accuracy requirements. Thus, in an example embodiment, the UE 10 may perform MBSFN measurements independent of the RCC state. This may provide more consistent UE 10 behavior for MBSFN measurements.

As described above, FIG. 3 illustrates a flowchart of an apparatus 20, method, and computer program product according to example embodiments of the invention. It will be understood that each block of the flowchart, and combinations of blocks in the flowchart, may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory device 24 of an apparatus employing an embodiment of the present invention and executed by a processor 22 of the apparatus. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowchart support combinations of means for performing the specified functions and combinations of operations for performing the specified functions for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included, such as illustrated by the dashed outline of block 36 in FIG. 3. Modifications, additions, or amplifications to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1-28. (canceled)

29. A method comprising:
receiving a multimedia broadcast single frequency network measurement request; and
measuring, at a user equipment, multimedia broadcast single frequency network parameters, wherein measurement of the multimedia broadcast single frequency network parameters is independent of the user equipment radio resource control state.

30. A method according to claim 29 further comprising causing transmission of the multimedia broadcast single frequency network measurement parameters.

31. A method according to claim 29 wherein measuring the multimedia broadcast single frequency network parameters is based on a multimedia broadcast monitoring or reception.

32. A method according to claim 29 wherein the multimedia broadcast single frequency network parameters comprise reference signal received power and reference signal received quality parameters.

33. A method according to claim 32 wherein measuring the multimedia broadcast single frequency network parameters comprises performing a received signal strength averaging associated with the reference signal received power or reference signal received quality parameters based on orthogonal frequency-division multiplexing symbols carrying multimedia broadcast single frequency network or multimedia broadcast multicast service (MBMS) reference signals.

34. A method according to claim 29 wherein measuring the multimedia broadcast single frequency network parameters comprises determining a multicast channel block error rate per modulation coding scheme per multimedia broadcast single frequency network area.

35. A method according to claim 29 wherein measuring the multimedia broadcast single frequency network parameters comprises is performed during sub-frames and carriers when the user equipment is decoding a physical multicast channel.

36. An apparatus comprising at least one processor and at least one memory including computer program code, wherein the memory and computer program code are configured to, with the processor, cause the apparatus to:
receive a multimedia broadcast single frequency network measurement request; and
measure, at a user equipment, multimedia broadcast single frequency network parameters, wherein measurement of the multimedia broadcast single frequency network parameters is independent of the user equipment radio resource control state.

37. An apparatus according to claim 36 wherein the memory and computer program code are further configured to, with the processor, cause the apparatus to cause transmission of the multimedia broadcast single frequency network measurement parameters.

38. An apparatus according to claim 36 wherein measurement of the multimedia broadcast single frequency network parameters is based on a multimedia broadcast monitoring or reception.

39. An apparatus according to claim 36 wherein the multimedia broadcast single frequency network parameters comprise reference signal received power and reference signal received quality parameters.

40. An apparatus according to claim 39 wherein the memory and computer program code are configured to, with the processor, cause the apparatus to measure the multimedia broadcast single frequency network parameters by performing a received signal strength averaging associated with the reference signal received power or reference signal received quality parameters based on orthogonal frequency-division multiplexing symbols carrying multimedia broadcast single frequency network or multimedia broadcast multicast service (MBMS) reference signals.

41. An apparatus according to claim 36 wherein the memory and computer program code are configured to, with the processor, cause the apparatus to measure the multimedia broadcast single frequency network parameters by determining a multicast channel block error rate per modulation coding scheme per multimedia broadcast single frequency network area.

42. An apparatus according to claim 36 wherein measurement of the multimedia broadcast single frequency network parameters comprises is performed during sub-frames and carriers when the user equipment is decoding a physical multicast channel.

43. A computer program product comprising at least one non-transitory computer readable medium having program code portions stored thereon, wherein the program code portions are configured, upon execution, to:
receive a multimedia broadcast single frequency network measurement request; and
measure, at a user equipment, multimedia broadcast single frequency network parameters, wherein the multimedia broadcast single frequency network measurement is independent of the user equipment radio resource control state.

44. A computer program product according to claim 43 wherein the program code portions are further configured to cause transmission of the multimedia broadcast single frequency network measurement parameters.

45. A computer program product according to claim 43 wherein measurement of the multimedia broadcast single frequency network parameters is based on a multimedia broadcast monitoring or reception.

46. A computer program product according to claim 43 wherein the multimedia broadcast single frequency network parameters comprise reference signal received power and reference signal received quality parameters.

47. A computer program product according to claim 46 wherein the program code portions configured to measure the multimedia broadcast single frequency network parameters comprise program code portions configured to perform a received signal strength averaging associated with the reference signal received power or reference signal received quality parameters based on orthogonal frequency-division multiplexing symbols carrying multimedia broadcast single frequency network or multimedia broadcast multicast service (MBMS) reference signals.

48. A computer program product according to claim 43 wherein the program code portions configured to measure the multimedia broadcast single frequency network parameters comprise program code portions configured to determine a multicast channel block error rate per modulation coding scheme per multimedia broadcast single frequency network area.
